(19) United States
(12) Patent Application Publication
(10) Pub. No.: US 2025/0065867 A1
(43) Pub. Date: Feb. 27, 2025

(54) AN APPARATUS FOR THE PATROLLING OF A MANOEUVERING LOCOMOTORY DEVICE

(71) Applicant: Gensol Electric Vehicles Private Limited, Pune (IN)

(72) Inventor: Pratik Gupta, Mumbai (IN)

(73) Assignee: Gensol Electric Vehicles Private Limited, Pune, MH (IN)

(21) Appl. No.: 18/727,753

(22) PCT Filed: Feb. 6, 2023
(86) PCT No.: PCT/IN2023/050115

§ 371 Date: Jul. 10, 2024

(30) Foreign Application Priority Data
Feb. 7, 2022 (IN) 202221006464

(51) Int. Cl. B60W 30/095; B60W 60/00

(52) U.S. Cl. CPC B60W 30/0956; B60W 60/0013; B60W 2520/105; B60W 2552/35

(57) ABSTRACT

An apparatus, for the patrolling of manoeuvring locomotory devices, is disclosed. Said apparatus broadly comprises: an at least a sensing member; and an at least a control member (108). Said at least one sensing member facilitates sensing of an at least a parameter, of a manoeuvring locomotory device (or an at least a parameter that is associated with said manoeuvring locomotory device), in real-time. Said at least one sensing member is communicatively associated with said at least one control member (108), which, in turn, is configured to facilitate monitoring and controlling of said apparatus. Said apparatus also comprises an alert generating member that generates an at least an alert. Said alert generating member is communicatively associated with said at least one control member (108). The disclosed apparatus offers at least the following advantages: is simple in construction; is cost-effective; and may be configured to be retrofitted (onto existing locomotory devices).

### FIELD OF THE INVENTION

The present disclosure is generally related to manoeuvring locomotory devices. Particularly, the present disclosure is related to the patrolling of manoeuvring locomotory devices. More particularly, the present disclosure is related to an apparatus, for the patrolling of manoeuvring locomotory devices.

### BACKGROUND OF THE INVENTION

Current technologies that are implemented, in manoeuvring locomotory devices, are expensive and greatly complex. Also, such technologies require powerful on-board computing resources, thus, pushing the costs for hardware and software even higher.

Further, most of these technologies rely on markings and signs, on a path of a manoeuvring locomotory device. The markings and signs are to be of a particular specification and quality. As a result, the current technologies are unusable, in situations, where paths are not marked, or signs are missing.

Thus, the purpose of the technologies is defeated, as they must: ensure safety of traveller(s) and surrounding pedestrians; not cause any obstructions, to flow of traffic; and not damage property.

Furthermore, weather conditions play a major role, with regards to the accuracy and predictability of the current technologies. Situations like heavy rains, fog, and snow, can highly compromise the visibility of manoeuvring locomotory devices, posing threats and safety concerns. In addition, most of the current technologies are useful, only at highway speeds and highway conditions, and lose their reliability and efficiency, in urban areas, where a lot of time is spent, in slow moving traffic.

There is, therefore, a need in the art, for: an apparatus, for the patrolling of manoeuvring locomotory devices, which can perform under all conditions, which overcomes the aforementioned drawbacks and shortcomings.

### SUMMARY OF THE INVENTION

An apparatus, for the patrolling of manoeuvring locomotory devices, is disclosed. Said apparatus broadly comprises: an at least a sensing member; an at least a control member; and an alert generating member.

Said at least one sensing member may be communicatively associated with a locomotory device. Said at least one sensing member facilitates sensing of an at least a parameter, of a manoeuvring locomotory device (or an at least a parameter that is associated with said manoeuvring locomotory device), in real-time.

Said at least one sensing member includes: an at least a motion sensing member; an at least a pot-hole sensing member; an at least an acceleration sensing member; an at least a radio detection and ranging sensing member; an at least a sound navigation and ranging sensing member; and/or an at least an image capturing member.

In an embodiment, said at least one parameter includes: distance, direction, and/or speed, of a vehicle that is manoeuvring ahead of (or in front of) said manoeuvring locomotory device; and/or conditions of a path, on which, said locomotory device is manoeuvring.

Said at least one motion sensing member and said at least one sound navigation and ranging sensing member sense objects, along said path, on which, said locomotory device is manoeuvring, in real-time. Data sensed, by said at least one motion sensing member and said at least one sound navigation and ranging sensing member, is (or are) transmitted, to said at least one control member.

Said at least one pot-hole sensing member senses height of a detected hole and height of a detected bump, along said path, on which, said locomotory device is manoeuvring, in real-time. Data sensed, by said at least one pot-hole sensing member, is (or are) transmitted, to said at least one control member.

Said at least one acceleration sensing member senses acceleration of said locomotory device, in real-time. Data sensed, by said at least acceleration sensing member, is (or are) transmitted, to said at least one control member.

Said at least one radio detection and ranging sensing member senses long-range objects, along said path, on which, said locomotory device is manoeuvring, in real-time. Data sensed, by said at least one radio detection and ranging sensing member, is (or are) transmitted, to said at least one control member.

Said at least one control member is configured to facilitate monitoring and controlling of said apparatus. Said at least one control member is communicatively associated with at least four actuators, which include: brakes; accelerator; steering; and indicator lights (or turn lights or turn signals).

Said at least one control member analyses said data received, from said at least one sensing member, compares said data, to an at least a threshold value (or an at least a threshold range, or an at least a respective threshold value, or an at least a respective threshold range), and transmits instructions, to said apparatus, to manoeuvre said locomotory device (to follow said vehicle directly ahead, while maintaining a safe distance, from it).

Said brakes are actuated, when: said vehicle that is manoeuvring ahead of (or in front of) said locomotory device is determined to be slowing down (or is determined to be stopping); said distance, to said vehicle that is manoeuvring ahead of (or in front of) said locomotory device, is determined as being lower than a lower limit, of a respective threshold range (or said distance, to said vehicle that is manoeuvring ahead of (or in front of) said locomotory device, is determined as being continuously decreasing); a pot-hole is detected, on said path; and/or an obstruction is detected, on said path.

Said accelerator is actuated, when: said vehicle that is manoeuvring ahead of (or in front of) said locomotory device is determined to be moving again (or is determined to be increasing its speed); said distance, to said vehicle that is manoeuvring ahead of (or in front of) said locomotory device, is determined as being higher than an upper limit, of said respective threshold range (or said distance, to said vehicle that is manoeuvring ahead of (or in front of) said locomotory device, is determined as being continuously increasing); said detected pot-hole is determined as having been crossed; and/or said detected obstruction no longer exists.

Said steering is actuated, when: said vehicle that is manoeuvring ahead of (or in front of) said locomotory device is determined to be turning; said vehicle that is manoeuvring ahead of (or in front of) said locomotory device is determined to be changing lanes; said pot-hole is detected, on said path; and/or said obstruction is detected, on said path.

Said indicator lights are actuated, when: said locomotory device changes lanes; and/or said locomotory device turns.

Said alert generating member generates an at least an alert, to an at least a user of said locomotory device. Said alert generating member is communicatively associated with said at least one control member. Said at least one alert is generated, by said alert generating member, upon said at least one control member's instructions.

If any discrepancies are determined (if said sensed data is or are determined as not being within said respective threshold ranges), by said at least one control member, said at least one control member transmits instructions, to said alert generating member (to generate said at least one alert).

In an embodiment, said apparatus comprises two image capturing members. One image capturing member, among said two image capturing members, senses attention levels of a driver (if said locomotory device is determined as being manoeuvred, in a manual mode), in real-time, with sensed data being transmitted, to said at least one control member.

Another image capturing member, among said two image capturing members, senses visual signals (signals or traffic lights, speed limit signs, no entry signs, and/or the like), in real-time, with sensed data being transmitted, to said at least one control member.

If said driver's eyes are determined as being closed, or if said driver's eyeballs are determined as not being focused, said at least one control member transmits instructions, to said alert generating member, to generate said at least one alert.

The disclosed apparatus offers at least the following advantages: is simple in construction; is cost-effective (may cost between about Rs. 10,000 and about Rs. 20,000); and may be configured to be retrofitted (onto existing locomotory devices).

### BRIEF DESCRIPTION OF THE DRAWINGS

FIG. 1 illustrates an apparatus, for the patrolling of manoeuvring locomotory devices, in accordance with an embodiment of the present disclosure; and

FIG. 2 illustrates a method of operation, of an apparatus, for the patrolling of manoeuvring locomotory devices, in accordance with an embodiment of the present disclosure

### DETAILED DESCRIPTION OF THE INVENTION

Throughout this specification, the use of the words “comprise” and “include”, and variations, such as “comprises”, “comprising”, “includes”, and “including”, may imply the inclusion of an element (or elements) not specifically recited. Further, the disclosed embodiments may be embodied, in various other forms, as well.

Throughout this specification, the use of the word “apparatus” is to be construed as: “a set of technical components (also referred to as “members”) that are communicatively and/or operably associated with each other, and function together, as part of a mechanism, to achieve a desired technical result ”.

Throughout this specification, the use of the words “communication”, “couple”, and their variations (such as communicatively), is to be construed as being inclusive of: one-way communication (or coupling); and two-way communication (or coupling), as the case may be, irrespective of the directions of arrows, in the drawings.

Throughout this specification, where applicable, the use of the phrase “at least” is to be construed in association with the suffix “one” or the suffix “four” i.e. it is to be read along with the suffix “one”, as “at least one”, which is used in the meaning of “one or more” (likewise for the other suffix). A person skilled in the art will appreciate the fact that the phrase “at least one” is a standard term that is used, in Patent Specifications, to denote any component of a disclosure, which may be present (or disposed) in a single quantity, or more than a single quantity (likewise for the other suffix).

Throughout this specification, the use of the word “plurality” is to be construed as being inclusive of: “at least one”.

Throughout this specification, the use of the word “patrolling”, and its variations, is to be construed as being inclusive of: “monitoring and controlling a manoeuvring locomotory device, to ensure that the manoeuvring locomotory device is at a safe distance, from a vehicle that is manoeuvring ahead of (or in front of it), during a journey that is undertaken (from a source to a destination), in the manoeuvring locomotory device”. A person skilled in the art will appreciate the fact that the safe distance will depend on factors, which include, but are not limited to: country-specific legislations; speed of manoeuvring; time of manoeuvring; and/or weather conditions, at the time of manoeuvring.

Throughout this specification, the use of the word “manoeuvring”, and its variations, is to be construed as “moving; and/or the like” (locomotory devices, in motion).

Throughout this specification, the use of the phrase “locomotory device”, and its variations, is to be construed as “autonomous vehicles; and/or the like”.

Throughout this specification, the use of the phrase “manoeuvring locomotory device”, and its variations, is to be construed as “moving autonomous vehicles; “autonomous vehicles in motion; and/or the like”.

Throughout this specification, the use of the phrase “application on a computing device”, and its variations, is to be construed as being inclusive of: application installable on a computing device; website hosted on a computing device; web application installed on a computing device; website accessible from a computing device; and/or web application accessible from a computing device.

Throughout this specification, the use of the phrase “computing device”, and its variations, is to be construed as being inclusive of: the cloud; remote servers; desktop computers; laptop computers; mobile phones; smart phones; tablets; phablets; and/or smart watches.

Throughout this specification, the use of the acronym “RADAR” is to be construed as: “Radio Detection and Ranging”.

Throughout this specification, the use of the acronym “SONAR” is to be construed as: “Sound Navigation and Ranging”.

Throughout this specification, the disclosure of a range is to be construed as being inclusive of: the lower limit of the range; and the upper limit of the range.

Throughout this specification, the words “the” and “said” are used interchangeably.

Throughout this specification, the phrases “at least a”, “at least an”, and “at least one” are used interchangeably.

Throughout this specification, the word “sensor” and the phrase “sensing member” are used interchangeably. The disclosed sensing members may be of any suitable type known in the art.

Throughout this specification, the word “controller”, the phrase “control member”, and the phrase “control system” are used interchangeably.

Also, it is to be noted that embodiments may be described as a method. Although the operations, in a method, are described as a sequential process, many of the operations may be performed in parallel, concurrently, or simultaneously. In addition, the order of the operations may be re-arranged. A method may be terminated, when its operations are completed, but may also have additional steps.

An apparatus, for the patrolling of manoeuvring locomotory devices (also referred to as “apparatus”), is disclosed. In an embodiment of the present disclosure, the apparatus broadly comprises an at least a sensing member that may be communicatively associated with a locomotory device (101). The at least one sensing member facilitates sensing of an at least a parameter, of a manoeuvring locomotory device (or an at least a parameter that is associated with said manoeuvring locomotory device), in real-time.

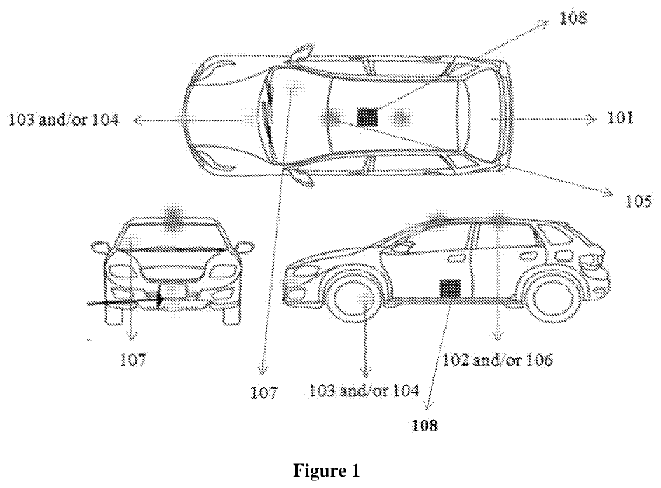

In another embodiment of the present disclosure, as illustrated, in FIG. 1, the at least one sensing member includes, but is not limited to: an at least a motion sensing member (102); an at least a pot-hole sensing member (103); an at least an acceleration sensing member (104); an at least a radio detection and ranging sensing member (105); an at least a sound navigation and ranging sensing member (106); and/or an at least an image capturing member (107; for example, a camera).

In yet another embodiment of the present disclosure, the at least one parameter includes, but is not limited to: distance, direction, and/or speed, of a vehicle that is manoeuvring ahead of (or in front of) the manoeuvring locomotory device; and/or conditions of a path, on which, the locomotory device (101) is manoeuvring.

The at least one sensing member is communicatively associated with an at least a control member (108) that is configured to facilitate monitoring and controlling of the apparatus. The at least one parameter (data) that is (or are) sensed, by the at least one sensing member, is (or are) transmitted, to the at least one control member (108).

In yet another embodiment of the present disclosure, the at least one control member (108) is a microcontroller.

In yet another embodiment of the present disclosure, the at least one control member (108) is a Single Board Computer.

In yet another embodiment of the present disclosure, the at least one control member (108) is a System on Chip.

The at least one control member (108) analyses the data received, from the at least one sensing member, compares the data, to an at least a threshold value (or an at least a threshold range, or an at least a respective threshold value, or an at least a respective threshold range), and transmits instructions, to the apparatus, to manoeuvre the locomotory device (101; to follow the vehicle directly ahead, while maintaining a safe distance, from it).

The apparatus also comprises an alert generating member that generates an at least an alert, to an at least a user of the locomotory device (101). The alert generating member is communicatively associated with the at least one control member (108).

For example, an alert is generated, if the at least one control member (108) determines that an obstruction has been sensed, on the path, by the at least one sensing member. In such situations, the at least one control member (108) may also transmit instructions, to the apparatus, to reduce speed and/or to stop.

In yet another embodiment of the present disclosure, the apparatus is configured, monitored, and controlled remotely, by the at least one user, through an application on a computing device. The at least one user interacts, with the apparatus, through a user interface (or display) of the computing device, which functions as an interface.

Results of the analyses performed, by the at least one control member (108), are displayed, on the user interface of the computing device. The at least one alert is also generated, through the application on a computing device. The at least one alert may be of any type known in the art, including, but not limited to: text messages; voice calls; alarms; buzzers; and/or the like.

Communicative association with the application on a computing device may occur, through wired or wireless technologies, such as: intranet; internet; mobile data; Bluetooth Low Energy; LoRa; ZigBee; and/or the like.

In yet another embodiment of the present disclosure, the at least one control member (108) is configured to be self-learning; it utilises information gathered, during previous manoeuvrings, to improve its performance and efficiency.

An extensive (or full-fledged knowledge base) is stored on the cloud, with a refined version of the knowledge base (or a fine-tuned version of the knowledge base, or a minimalistic version of the knowledge base, or a compressed version of the knowledge base, or a pruned version of the knowledge base) being stored on the at least one control member (108).

The knowledge base on the cloud syncs, at regular, periodic intervals, with the at least one control member (108), and is configured to learn and improve itself, based on the data received continuously, from the at least one control member (108).

A person skilled in the art will appreciate the fact that the apparatus may be powered, by an at least a power source. The at least one power source may be of any suitable type known in the art. For example, the at least one power source is a rechargeable battery.

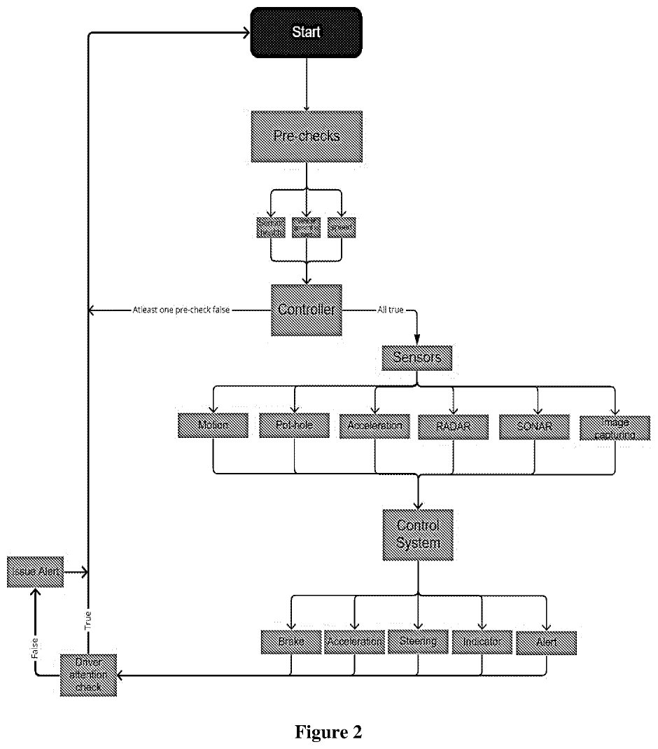

FIG. 2 illustrates a method of the apparatus's operation. Once the apparatus is switched on, the at least one control member (108) transmits instructions, to the apparatus, to determine, whether: the locomotory device (101) is in motion (this may be determined, based on a threshold speed); a vehicle is manoeuvring ahead of (or in front of) the locomotory device (101); and the at least one sensing member is in order (this may be determined, based on responsiveness, to a test signal).

These determinations (also referred to as “pre-checks”), may be performed, through any suitable technologies known in the art.

On the basis of the pre-checks, if the at least one control member (108) determines that: the locomotory device (101) is in motion; the vehicle is manoeuvring ahead of (or in front of) the locomotory device (101); and the at least one sensing member is in order, it proceeds further.

On the other hand, if any of the pre-checks fail, the at least one control member (108) transmits instructions, to the apparatus, to perform the same again. If the pre-checks consecutively fail, for a pre-defined number of times (for example, three times), the at least one control member (108) transmits instructions, to the alert generating member, to generate the at least one alert.

Upon proceeding further, the at least one motion sensing member (102), the at least one pot-hole sensing member (103), the at least one acceleration sensing member (104), the at least one radio detection and ranging sensing member (105), the at least one sound navigation and ranging sensing member (106); and/or the at least one image capturing member (107), sense: the distance, direction, and/or speed, of the vehicle that is manoeuvring ahead of (or in front of) the manoeuvring locomotory device; and/or the conditions of the path, on which, the locomotory device (101) is manoeuvring, in real-time, with sensed data being transmitted, to the at least one control member (108).

The at least one control member (108), in turn, is communicatively associated with at least four actuators, which include, but are not limited to: brakes; accelerator; steering; and indicator lights (or turn lights or turn signals).

The brakes are actuated, when: the vehicle that is manoeuvring ahead of (or in front of) the locomotory device (101) is determined to be slowing down (or is determined to be stopping); the distance, to the vehicle that is manoeuvring ahead of (or in front of) the locomotory device (101), is determined as being lower than a lower limit, of a respective threshold range (or the distance, to the vehicle that is manoeuvring ahead of (or in front of) the locomotory device (101), is determined as being continuously decreasing); a pot-hole is detected, on the path; and/or an obstruction is detected, on the path.

The accelerator is actuated, when: the vehicle that is manoeuvring ahead of (or in front of) the locomotory device (101) is determined to be moving again (or is determined to be increasing its speed); the distance, to the vehicle that is manoeuvring ahead of (or in front of) the locomotory device (101), is determined as being higher than an upper limit, of the respective threshold range (or the distance, to the vehicle that is manoeuvring ahead of (or in front of) the locomotory device (101), is determined as being continuously increasing); the detected pot-hole is determined as having been crossed; and/or the detected obstruction no longer exists.

The steering is actuated, when: the vehicle that is manoeuvring ahead of (or in front of) the locomotory device (101) is determined to be turning; the vehicle that is manoeuvring ahead of (or in front of) the locomotory device (101) is determined to be changing lanes; the pot-hole is detected, on the path; and/or the obstruction is detected, on the path.

The indicator lights are actuated, when: the locomotory device (101) changes lanes; and/or the locomotory device (101) turns.

In yet another embodiment of the present disclosure, the threshold range, in respect of the distance, to the vehicle that is manoeuvring ahead of (or in front of) the locomotory device (101), and corresponding speeds, at which, the at least one control member (108) instructs the locomotory device (101), to manoeuvre, are as follows:

| Weather | Distance (m) | Speed (m/s) |
|---|---|---|
| Sunny (clear) | About 0.5-55 | About 0-25 |
| Fog (decreased visibility) | About 0.5-25 | About 0-10 |
| High Precipitation (slippery) | About 0.5-50 | About 0-20 |

A person skilled in the art will appreciate the fact that the weather may be determined, through any suitable technologies known in the art.

Relative velocity and acceleration are calculated, from rate of change of the distance:

Relative Velocity: velocity=rate of change of distance

Relative Acceleration:
acceleration=rate of change of relative velocity

The relative velocity and the relative distance are to be kept, as close to zero, as possible.

### Turning Radius

Rate of turning the steering is calculated as follows:

$$Turning rate = \frac{Rate of lateral displacement of vehicle in front}{Distance between the 2 cars}$$

In the above formula, “vehicle in front” refers to the vehicle that is manoeuvring ahead of (or in front of) the locomotory device (101). Likewise, “distance between the 2 cars” refers to the distance, to the vehicle that is manoeuvring ahead of (or in front of) the locomotory device (101).

In yet another embodiment of the present disclosure, the at least one control member (108) analyses the data received, from the at least one sensing member, in accordance with the following:

### The At Least One Motion Sensing Member (102; For Example, An Ultrasonic Sensor) and/or the at Least One Sound Navigation and Ranging Sensing Member (106)

The at least one motion sensing member (102) and/or the at least sound navigation and ranging sensing member (106) sense objects, along the path (and in the vicinity of the path), on which, the locomotory device (101) is manoeuvring, in real-time, with the sensed data being transmitted, to the at least one control member (108).

The Objects detected are classified, into three categories: far away objects (distance (m)>about twice the speed (m/s) of the locomotory device (101)); nearby objects (distance (m) is between about twice and about 1×, of the speed (m/s) of the locomotory device (101)); and objects in the immediate vicinity (distance (m)<the speed (m/s) of the locomotory device (101)).

Detecting range is at least twice the maximum permissible distance, in sunny weather (about 55 m).

In any lane, the distance (m), between the locomotory device (101) and a nearby object in motion, is configured to not cross about twice the speed of the locomotory device (101; in m/s). For example, the speed of the locomotory device (101) is about 15 m/s. Therefore, the distance that is to be maintained, at about 30 m.

In case the locomotory device (101) is between two vehicles, a distance that is about twice the speed of the locomotory device (101) is maintained, between the locomotory device (101) and the vehicle that is manoeuvring ahead of (or in front of) the locomotory device (101).

If moving objects detected are on the left hand side and/or right hand side of the locomotory device (101), the threshold distance is configured to be about 0.75 times to about 1×, of the width of the lane (depending on traffic rules).

### The at Least One Pot-Hole Sensing Member (103; For Example, an Inertial Measurement Unit sensor)

Input: Acceleration, in the vertical direction (z axis).

The at least one pot-hole sensing member (103) senses height of a detected hole and/or a detected bump, along the path, on which, the locomotory device (101) is manoeuvring, in real-time, with the sensed data being transmitted, to the at least one control member (108).

The height of a detected hole is estimated as follows:

$$h = [ {\int }_{t 1}^{t 2} a \cdot dt ] \div 2$$

Where: h denotes height of the detected pothole; a denotes the acceleration; and t1 and t2 denote times, when the acceleration (in vertical direction) becomes greater than about 0m/s² and reaches about 0 m/s² again, respectively.

The detected hole is determined to be a pothole, only if its depth exceeds about 40 mm. Similarly, the detected bump is considered as a speed bump, only if its height exceeds about 40 mm.

### The at Least One Acceleration Sensing Member (104; For Example, an Inertial Measurement Unit sensor)

The at least one acceleration sensing member (104) senses acceleration of the locomotory device (101), in real-time, with the sensed data being transmitted, to the at least one control member (108). The acceleration of the locomotory device (101) is sensed, along all three directions (x, y and z axes), along with momentum.

The threshold values (or threshold ranges) are in accordance, with the locomotory device (101) manufacturer's (OEM) recommendations.

### The at Least One Radio Detection and Ranging Sensing Member (105)

Input: Distance (in m).

The at least one radio detection and ranging sensing member (105) senses long-range objects, along the path (and in the vicinity of the path), on which, the locomotory device (101) is manoeuvring, in real-time, with the sensed data being transmitted, to the at least one control member (108). A person skilled in the art will appreciate the meaning of the phrase “long-range”, in the context of radio detection and ranging sensing members.

The threshold value, in respect of the vehicle that is manoeuvring ahead of (or in front of) the locomotory device (101), is configured to be about twice the speed of the locomotory device (101).

If an obstacle is determined as being detected, between the locomotory device (101) and the vehicle that is manoeuvring ahead of (or in front of) the locomotory device (101), and the vehicle that is manoeuvring ahead of (or in front of) the locomotory device (101) is determined as not being detected, the at least one control member (108) transmits instructions, to the apparatus, to stop the locomotory device (101).

If the moving objects detected are on the left hand side and/or right hand side of the locomotory device (101), the threshold distance (perpendicular distance) is configured to be about 0.75 times to about 1×, of the width of the lane (depending on traffic rules).

If any discrepancies are determined (if the sensed data is or are determined as not being within the respective threshold ranges), by the at least one control member (108), based on the above analyses, the at least one control member (108) transmits instructions, to the alert generating member, to generate the at least one alert.

### The at Least One Image Capturing Member (107)

In yet another embodiment of the present disclosure, the apparatus comprises two image capturing members. One image capturing member, among the two image capturing members, senses attention levels of a driver (if the locomotory device (101) is determined as being manoeuvred, in a manual mode), in real-time, with the sensed data being transmitted, to the at least one control member (108).

Another image capturing member, among the two image capturing members, senses visual signals (signals or traffic lights, speed limit signs, no entry signs, and/or the like), in real-time, with the sensed data being transmitted, to the at least one control member (108).

A person skilled in the art will appreciate the fact that the attention levels of the driver and the visual signs may be determined, through any suitable technologies known in the art.

If the driver's eyes are determined as being closed, for at least about two consecutive seconds, or if the driver's eyeballs are determined as not being focused, on the path ahead, for at least about two consecutive seconds, the at least one control member (108) transmits instructions, to the alert generating member, to generate the at least one alert.

In yet another embodiment of the present disclosure, the apparatus comprises two control members. One control member, among the two control members, is configured to perform the pre-checks, while another control member, among the two control members, is configured to perform data analyses. Said two control members are communicatively associated with each other.

The below Table is a summary of the information disclosed above:

| Sensor | Input Type | Possible Actions | Actuation |
|---|---|---|---|
| Motion Sensing | Distance Value | Start or Stop Vehicle | Accelerator or Brake |
| Member/SONAR Sensing | | Issue Alert | — |
| Member | | Increase or Decrease Speed | Accelerator or Brake |
| | | Steer Vehicle | Steering and/or Indicator |
| Pot-Hole Sensing Member | Acceleration Value | Decease Speed | Brake |
| | | Steer Vehicle | Steering and/or Indicator |
| Acceleration Sensing | Acceleration Values - x, | Issue Alert | — |
| Member | y, and z Directions | Decrease Vehicle Speed | Brake |
| RADAR Sensing Member | Distance Value | Start or Stop Vehicle | Accelerator or Brake |
| | | Issue Alert | — |
| | | Increase or Decrease Speed | Accelerator or Brake |
| | | Steer Vehicle | Steering and/or Indicator |
| Image Capturing Member | Image Feed | Start or Stop Vehicle | Accelerator or Brake |
| | | Issue Alert | — |

The disclosed apparatus offers at least the following advantages: is simple in construction; is cost-effective (may cost between about Rs. 10,000 and about Rs. 20,000); and may be configured to be retrofitted (onto existing locomotory devices).

A person skilled in the art will appreciate the fact that the apparatus, and its various components, may be made of any suitable materials known in the art. Likewise, a person skilled in the art will also appreciate the fact that the configurations of the apparatus, and its various components, may be varied, based on requirements.

Implementation of the disclosure can involve performing or completing selected tasks manually, automatically, or a combination thereof. Further, according to actual instrumentation of the disclosure, several selected tasks could be implemented, by hardware, by software, by firmware, or by a combination thereof, using an operating system.

For example, as software, selected tasks according to the disclosure could be implemented, as a plurality of software instructions being executed, by a computing device, using any suitable operating system.

In yet another embodiment of the disclosure, one or more tasks, according to embodiments of the disclosure, is (or are) performed, by a data processor, such as a computing platform, for executing a plurality of instructions. Further, the data processor includes a processor, and/or non-transitory computer-readable medium, for storing instructions and/or data, and/or a non-volatile storage, for storing instructions and/or data. A network connection, a display, and/or a user input device such as a keyboard (or mouse) are also provided.

It will be apparent to a person skilled in the art that the above description is for illustrative purposes only and should not be considered as limiting. Various modifications, additions, alterations, and improvements, without deviating from the spirit and the scope of the disclosure, may be made, by a person skilled in the art. Such modifications, additions, alterations, and improvements should be construed as being within the scope of this disclosure.

### LIST OF REFERENCE NUMERALS

101—Locomotory Device
102—At Least One Motion Sensing Member
103—At Least One Pot-Hole Sensing Member
104—At Least One Acceleration Sensing Member
105—At Least One Radio Detection and Ranging Sensing Member
106—At Least One Sound Navigation and Ranging Sensing Member
107—At Least One Image Capturing Member
108—At Least One Control Member

We claim:

1. An apparatus, for the patrolling of manoeuvring locomotory devices, comprising:
an at least a sensing member, said at least one sensing member: facilitating sensing of an at least a parameter, of a manoeuvring locomotory device, in real-time; and including:
an at least a motion sensing member (102) and an at least a sound navigation and ranging sensing member (106), said at least one motion sensing member (102) and said at least one sound navigation and ranging sensing member (106) sensing objects, along a path, on which, said locomotory device (101) is manoeuvring, in real-time, with sensed data being transmitted, to an at least a control member (108);
an at least a pot-hole sensing member (103), said at least one pot-hole sensing member (103) sensing height of a detected hole and height of a detected bump, along said path, on which, said locomotory device (101) is manoeuvring, in real-time, with sensed data being transmitted, to said at least one control member (108);
an at least an acceleration sensing member (104), said at least one acceleration sensing member sensing acceleration of said locomotory device (101), in real-time, with sensed data being transmitted, to said at least one control member (108); and
an at least a radio detection and ranging sensing member (105), said at least one radio detection and ranging sensing member (105) sensing long-range objects, along said path, on which, said locomotory device (101) is manoeuvring, in real-time, with sensed data being transmitted, to said at least one control member (108);
said at least one control member (108) that is configured to facilitate monitoring and controlling of said apparatus, said at least one control member (108):
being communicatively associated with at least four actuators, said at least four actuators including: brakes; accelerator; steering; and indicator lights;
comparing said data received, from said at least one sensing member, to an at least a threshold value, or an at least a threshold range; and
transmitting instructions, to said apparatus, to manoeuvre said locomotory device (101), based on the results of said comparison; and
an alert generating member that generates an at least an alert, upon said at least one control member's (108) instructions,
with:
said brakes being actuated, when: a vehicle that is manoeuvring ahead of said locomotory device (101) is determined to be slowing down; a pot-hole is detected, on said path; or an obstruction is detected, on said path;
said accelerator being actuated, when: said vehicle that is manoeuvring ahead of said locomotory device (101) is determined to be increasing its speed; said detected pot-hole has been crossed; or said detected obstruction no longer exists;
said steering being actuated, when: said vehicle that is manoeuvring ahead of said locomotory device (101) is determined to be turning; said vehicle that is manoeuvring ahead of said locomotory device (101) is determined to be changing lanes; said pot-hole is detected, on said path; or said obstruction is detected, on said path; and
said indicator lights being actuated, when: said locomotory device (101) changes lanes; or said locomotory device (101) turns.

2. The apparatus, for the patrolling of manoeuvring locomotory devices, as claimed in claim 1, wherein:
said at least one parameter includes: distance, direction, and speed, of said vehicle that is manoeuvring ahead of said manoeuvring locomotory device; and conditions of said path, on which, said locomotory device (101) is manoeuvring.

3. The apparatus, for the patrolling of manoeuvring locomotory devices, as claimed in claim 1, wherein: said at least one control member (108) is a microcontroller.

4. The apparatus, for the patrolling of manoeuvring locomotory devices, as claimed in claim 1, wherein: said at least one control member (108) is a Single Board Computer.

5. The apparatus, for the patrolling of manoeuvring locomotory devices, as claimed in claim 1, wherein: said at least one control member (108) is a System on Chip.

6. The apparatus, for the patrolling of manoeuvring locomotory devices, as claimed in claim 1, wherein:
said apparatus is configured, monitored, and controlled remotely, through an application on a computing device.

7. The apparatus, for the patrolling of manoeuvring locomotory devices, as claimed in claim 1, wherein: said at least one motion sensing member (102) is an ultrasonic sensor.

8. The apparatus, for the patrolling of manoeuvring locomotory devices, as claimed in claim 1, wherein: said at least one pot-hole sensing member (103) is an Inertial Measurement Unit sensor.

9. The apparatus, for the patrolling of manoeuvring locomotory devices, as claimed in claim 1, wherein: said at least one acceleration sensing member (104) is an Inertial Measurement Unit sensor.

10. The apparatus, for the patrolling of manoeuvring locomotory devices, as claimed in claim 1, wherein:
said apparatus comprises two image capturing members, with:
one image capturing member, among said two image capturing members, sensing attention levels of a driver, in real-time, with sensed data being transmitted, to said at least one control member (108); and
another image capturing member, among said two image capturing members, sensing visual signals, in real-time, with sensed data being transmitted, to said at least one control member (108),
with: said at least one control member (108) transmitting instructions, to said alert generating member, to generate said at least one alert, if: said driver's eyes are determined as being closed; or if said driver's eyeballs are determined as not being focused.

11. The apparatus, for the patrolling of manoeuvring locomotory devices, as claimed in claim 1, wherein: said apparatus is configured to be retrofitted, onto existing locomotory devices.
